(19) United States
(12) Patent Application Publication
(10) Pub. No.: US 2018/0235190 A1
(43) Pub. Date: Aug. 23, 2018

(54) BEEHIVE VENTILATION AND ENTRANCE ADJUSTMENT SYSTEM

(71) Applicant: Dan's Woodworking Inc., Abbotsford (CA)

(72) Inventor: Daniel VAANDRAGER, Abbotsford (CA)

(21) Appl. No.: 15/871,454

(22) Filed: Jan. 15, 2018

(30) Foreign Application Priority Data
Feb. 22, 2017 (CA) 2958948

(51) Int. Cl. A01K 47/06

(52) U.S. Cl. CPC A01K 47/06; A01K 47/02

(57) ABSTRACT

A system ventilation and entrance adjustment for a beehive is provided. The system includes: a first panel comprising a first cutout and an entrance adjustment portion flanking the first cutout; and a second panel disposed rearward of the first panel and comprising a second cutout. The first panel is slidable relative to the second panel. In a closed configuration the entrance adjustment portion blocks the second cutout to prevent bees from passing through, and in an open configuration the entrance adjustment portion either does not block, or only partially blocks, the second cutout to allow bees to pass through. The first panel and the second panel each comprise ventilation means. In the closed configuration and in the open configuration the ventilation means of the first panel are arranged to at least partially overlap with the ventilation means of the second panel to allow air to flow through the system.

### TECHNICAL FIELD

This invention relates to a beehive ventilation and entrance adjustment system.

### BACKGROUND

Maintaining healthy beehives is an important aspect of modern beekeeping. Beehive ventilation promotes honey bee health and productivity by regulating the moisture and temperature inside the beehive. Pests such as wasps and small rodents must be kept away from beehives to ensure bee colony survival. Improved systems for ventilating and keeping pests out of beehives are desirable.

### SUMMARY

The inventions described herein have many aspects, some of which relate to systems for ventilation and entrance adjustment for a beehive.

In one aspect, a system ventilation and entrance adjustment for a beehive is provided. The system includes: a first panel comprising a first cutout and an entrance adjustment portion flanking the first cutout; and a second panel disposed rearward of the first panel and comprising a second cutout. The first panel is slidable relative to the second panel. In a closed configuration the entrance adjustment portion blocks the second cutout to prevent bees from passing through, and in an open configuration the entrance adjustment portion either does not block, or only partially blocks, the second cutout to allow bees to pass through. The first panel and the second panel each comprise ventilation means. In the closed configuration and in the open configuration the ventilation means of the first panel are arranged to at least partially overlap with the ventilation means of the second panel to allow air to flow through the system.

The system may also include a guide assembly, the guide assembly comprising an upper guide and a lower guide, the upper guide configured to receive upper edges of the first panel and the second panel, and the lower guide configured to receive lower edges of the first panel and the second panel, wherein the lower guide has cutouts corresponding to the second cutouts of the second panel.

The upper guide and the bottom guide may each comprise double U-shaped channels for receiving the upper and lower edges of the first and second panels. Alternatively, the second panel may be integral with the upper guide and the lower guide, and the upper guide and the lower guide may each comprise a U-shaped channel for receiving the upper and lower edges of the first panel.

The lower guide may comprise a cutout corresponding in location to the second cutout. A height of the first cutout and a height of the second cutout may be substantially equal. The heights of the first and second cutouts may range from ⅜″ to ½″. The widths of the first and second cutouts may range from 1″ to 3″. The first cutout may be located along a lower edge of the first panel and the second cutout may be located along a lower edge of the second panel. Side edges of the first and second cutouts may angle outward in the downward direction.

The second panel may span an entrance width of the beehive. A width of the second panel may range from 6″ to 18″. A width of the second panel may be about 16½″ or about 7¾″.

A height of the first panel and a height of second panel may be substantially the same. A height of the first and second panels may be about 1¾″. The second panel may be fixed. A distance between the first panel and the second panel may be no greater than ⅛″. The first panel and the second panel may be constructed from 1/16″ thick UV resistant polyvinyl chloride (PVC).

The ventilation means may account for at least 25% of the surface area each of the first panel and the second panel. The ventilation means may comprise perforations. The perforations may be substantially evenly distributed across the first panel and the second panel. The perforations may be about ⅛″ in diameter. Alternatively, the ventilation means may comprise slits. The slits may be substantially evenly distributed across the first panel and the second panel. The slits may be no more than ⅛″ in width.

In another aspect, a beehive is provided. The beehive includes: a top cover; a plurality of supers; a bottom board defining an entrance; and a system as described herein at the entrance for ventilating the beehive and adjusting the size of the entrance. The second cutout may be centrally located along a width of the bottom board. The beehive may include fastening means for fastening the system to the beehive. The beehive may be a Langstroth beehive.

The foregoing discussion merely summarizes certain aspects of the inventions and is not intended, nor should it be construed, as limiting the inventions in any way.

### BRIEF DESCRIPTION OF DRAWINGS

The accompanying drawings illustrate non-limiting example embodiments of the invention.

FIG. 1 is a front view of a bee hive as known in the art;

FIGS. 2A to 2C show front views of a beehive ventilation and entrance adjustment system according to an embodiment of the invention in various configurations as described herein;

FIG. 3 is a cross sectional view of the system shown in FIGS. 2A to 2C;

FIG. 4 is an exploded view of the system shown in FIGS. 2A to 2C;

FIG. 5 is a front view of a bee hive incorporating the system shown in FIGS. 2A to 2C;

FIG. 6 is a cross sectional view of a beehive ventilation and entrance adjustment system according to an embodiment of the invention;

FIG. 7 is a front view of a beehive ventilation and entrance adjustment system according to an embodiment of the invention; and

FIG. 8 is a front view of a beehive ventilation and entrance adjustment system according to an embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

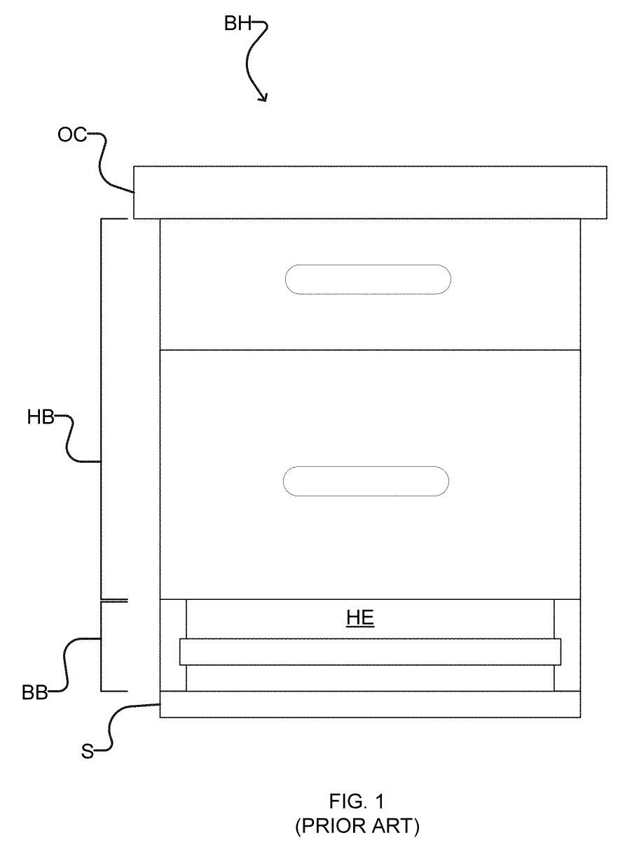

FIG. 1 shows a typical bee hive BH as known in the art. Bee hive BH includes an outer cover OC, a hive body HB comprising a plurality of supers, a bottom board BB, and a stand S. Bottom board BB defines an entrance HE at the bottom of bee hive BH. Bee hive BH also has interior components that are not shown such as an inner cover on top of the top super, and frames hung in each super.

To prevent pests from entering bee hive BH, it is known in the art to place a small wooden block with (also known as an entrance reducer) at the hive entrance HE. The block is provided with a hole dimensioned small enough to allow bees, but not pests, to access bee hive BH therethrough. However, placing the block at hive entrance HE greatly reduces ventilation of bee hive BH, and the ability to regulate bee traffic is limited because of fixed size of the hole in the block.

Aspects of the present invention relate to a system usable employable on existing standard beehives to provide ventilation, bee traffic control, and pest exclusion. The system comprises overlapping and ventilated panels covering the beehive entrance. The system includes a front panel slidable relative to a back panel to adjust overlap between respective cutouts in the panels, thereby adjust the size of the entrance to the beehive.

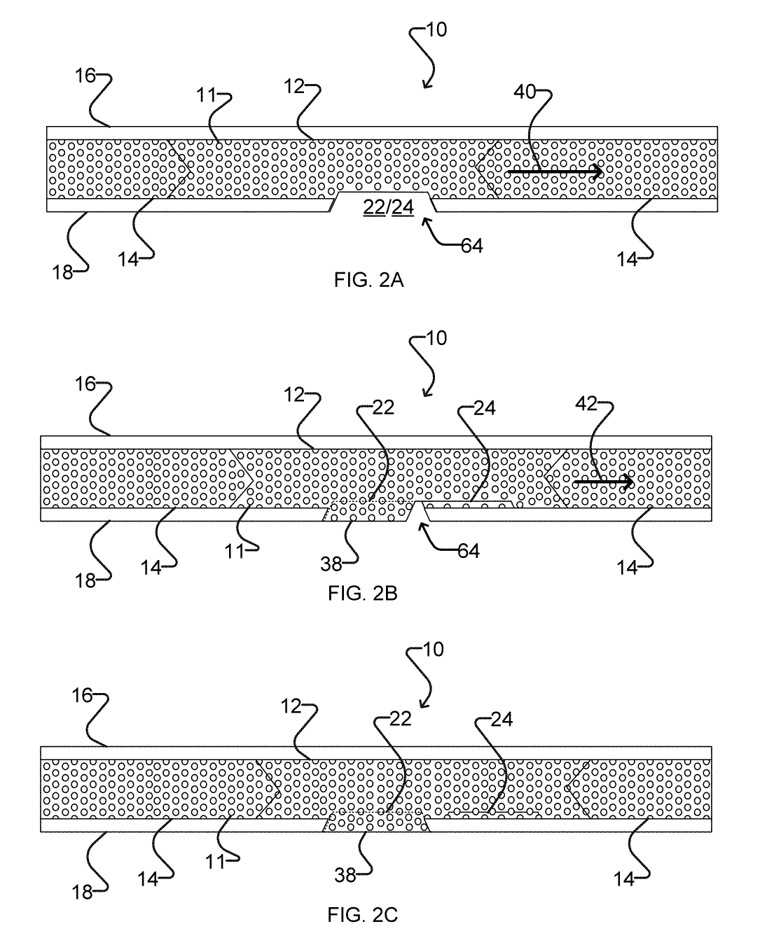

FIGS. 2 to 4 show a beehive ventilation and entrance adjustment system 10 according to an embodiment of the invention. System 10 includes a front panel 12 and a back panel 14. Front panel 12 and back panel 14 are secured by a guide assembly 20 comprising an upper guide 16 and a lower guide 18.

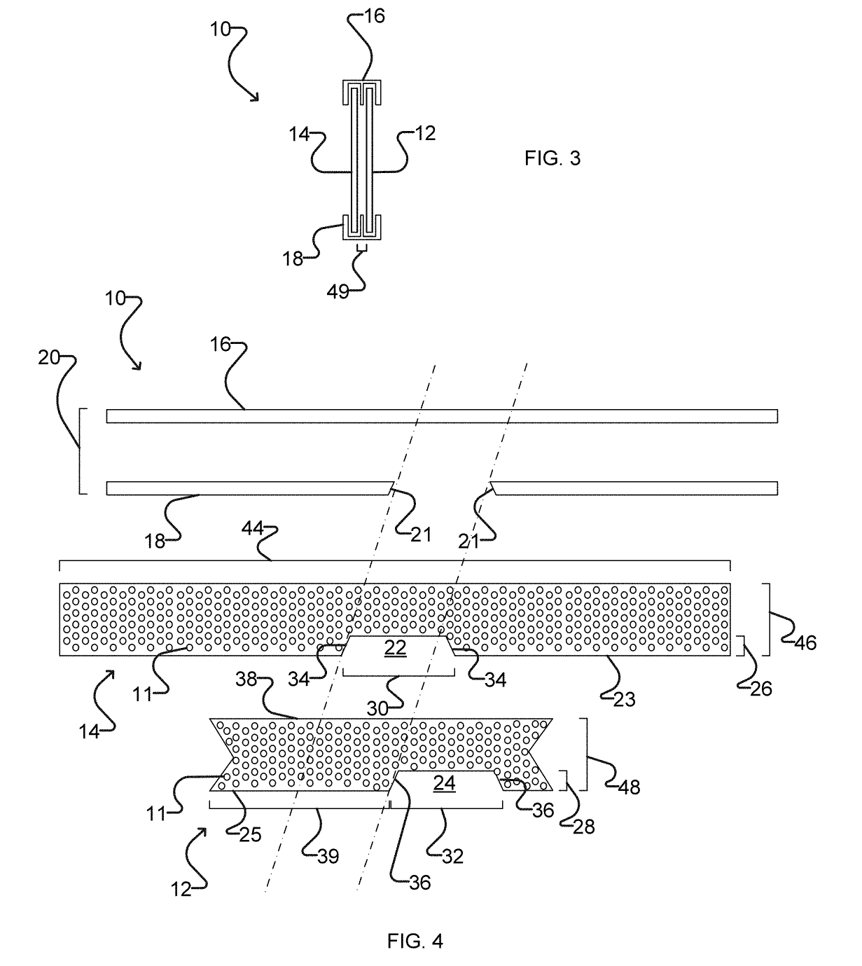

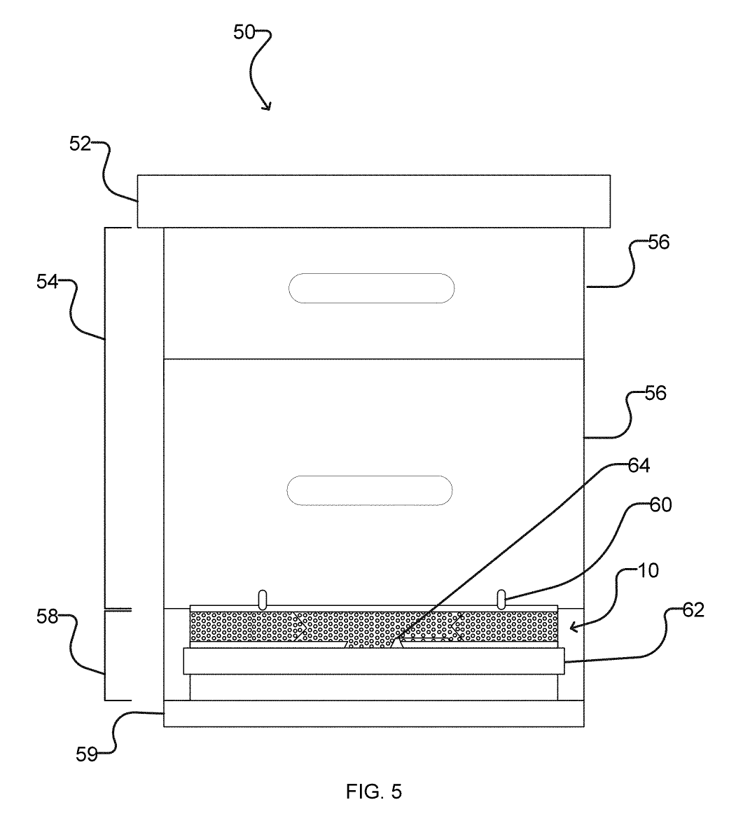

As shown in FIG. 3, upper guide 16 and lower guide 18 each have two “U” shaped channels that respectively receive the upper and lower edges of front panel 12 and back panel 14 to substantially prevent any vertical displacement of front panel 12 and back panel 14. Front panel 12 is slidable for horizontal displacement along guide assembly 20. Back panel 14 is sized to span the width of hive entrance (see FIG. 5) so is substantially prevented from any horizontal displacement.

Back panel 14 has a cutout 22 along its bottom edge 23. Front panel 12 also has a cutout 24 along its bottom edge 25. Lower guide 18 has cutouts 21 corresponding to cutout 22 of back panel 14.

Front panel 12 also has a flanking portion 38 directly beside cutout 24. The width 39 of flanking portion 38 is at least as wide as width 30 of cutout 22 for reasons that will become apparent next.

As shown in FIGS. 2A to 2C, front panel 12 slides horizontally within guide assembly in front of back panel 14 to control the size (and specifically, the width) of entrance 64 of system 10 into the beehive. FIG. 2A shows system 10 in an open configuration, where cutout 24 of front panel 12 completely overlaps cutout 22 of back panel 14. The size of entrance 64 to the beehive is thus defined by the size of cutouts 22, 24. This open configuration may be used for example when: maximum bee traffic is desired; maximum ventilation is desired; and/or there is minimal possibility of robbing or attack by pests.

When one or more of these circumstances change, a user can slide front panel 12 in the direction of arrow 40, to configure system 10 in a partially open configuration for example as shown in FIG. 2B. In FIG. 2B, flanking portion 38 of front panel 12 closes off most of cutout 22 of back panel 14, leaving an entrance 64 into the beehive that is approximately two bee widths wide. The partially open configuration may be adjusted wider or narrower than shown in FIG. 26 as required by the user.

Front panel 12 shown in FIG. 26 can be further slid in the direction of arrow 42, to configure system 10 in a closed configuration for example as shown in FIG. 2C. Flanking portion 38 of front panel 12 now completely closes off cutout 22 of back panel 14. Flanking portion 38 thus must be at least as wide as width 30 of cutout 22 in order to close off cutout 22 completely in the closed configuration.

In some embodiments, front panel 12 and/or the channels in upper guide 16 and lower guide 18 in which front panel 12 slides may be dimensioned for a friction fit, to prevent inadvertent sliding of front panel 12 and to prevent small animals from sliding front panel 12.

Cutout 22 and cutout 24 are similarly dimensioned. For example, height 26 of cutout 22 and height 28 of cutout 24 may range from ⅜″ to ½″, and width 30 of cutout 22 and width 32 of cutout 24 may range from 1″ to 3″.

The side edges 34 of cutout 22 and the side edges 36 of cutout 24 each angle outward in the downward direction. The angled side edges maximize the space for bees to walk abreast on the bottom board (see FIG. 5) through the cutouts while minimizing unnecessary open space above the bees. In embodiments where ventilation means 11 are in a staggered arrangement (such as shown in the illustrated embodiments), the angled side of the cutouts avoid any partially cut ventilation means 11.

In particular embodiments, front panel 12 and back panel 14 may each be about 1/16″ thick. The width 44 of back panel 14 is defined by the width of the entrance of the beehive, and may range from 6″ to 18″. In particular embodiments, width 44 of back panel 14 may be about 7¾″ or about 16½″. The height 46 of back panel 14 and the height 48 of front panel 12 are substantially the same and may range from 1″ to 3″. In particular embodiments, height 46 and height 48 may be about 1¾″. As shown in FIG. 3, a distance 49 may be defined between front panel 12 and back panel 14. In some embodiments distance 49 may be no greater than ⅛″.

Front panel 12 and back panel 14 each have an array of ventilation means 11 substantially evenly distributed across them. In particular embodiments, ventilation means 11 may account for at least 25%, or at least 35%, of the surface area of each of front panel 12 and back panel 14.

Ventilation means 11 may be perforations such as the round holes in the illustrated embodiments. In the closed configuration and in the open configuration ventilation means 11 of front panel 12 are arranged to at least partially overlap with ventilation means 11 of back panel 14, even with incremental horizontal displacement (e.g. ⅛″ to ¼″) of the front panel 12, to readily allow air to flow through system 10 into and out of the beehive in multiple configurations of system 10.

In some embodiments, system 10 may be provided with fastening means 60 as shown in FIG. 5 to allow system 10 to be installed, removably or permanently, on existing beehives.

FIG. 5 shows a beehive 50 incorporating beehive ventilation and entrance adjustment system 10. Beehive 50 is a standard Langstroth beehive with an outer cover 52, a hive body 54 comprising a plurality of supers 56, a bottom board 58, and a stand 59. Fastening means 60 fasten system 10 to cover the hive entrance at bottom board 58. Bees can fly through entrance 64 of system 10 and/or land on an upper surface of base 62 and walk through entrance 64. In some embodiments the ventilation means of system 10 and any opening of entrance 64 are the only means of ventilation for the entire beehive 50.

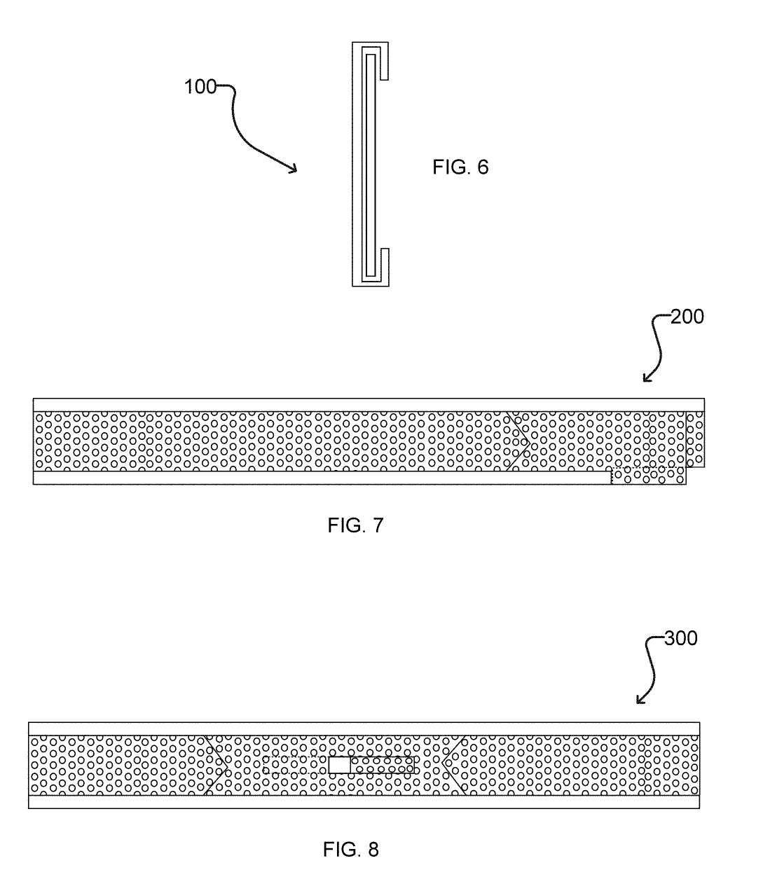

This application is intended to cover any variations, uses, or adaptations of the invention using its general principles. For example, in some embodiments:
The cutouts may be differently dimensioned. The size of the opening through the system into the beehive depends on the size of the smaller cutout if the cutouts are of different sizes. In some embodiments, the size of the cutout of the back panel may be larger than the size of the cutout of the front panel, and in other embodiments the size of the cutout of the back panel may be smaller than the size of the cutout of the front panel.
The second panel may be integral with the upper guide and the lower guide. In such an embodiment, the upper guide and the lower guide each comprise a single U-shaped channel for receiving the upper and lower edges of the first panel, as shown in system 100 in FIG. 6.
Instead of two U-shaped channels, the front panel and back panel may be received together in only one U-shaped channel in each of the upper and lower guides, leaving substantially no distance 49 between the front and back panels.
The cutout of the back panel may be located other than at a central lower edge of the back panel. In some embodiments the cutouts of the front and back panels may be formed along the upper edge of the panels. Or, as shown in FIG. 7, for example, in system 200 the cutout of the back panel may be located at the side edge of the back panel. FIG. 7 shows system 200 in a partially open configuration. In system 100, the front panel does not have a cutout. Or, as shown in FIG. 8, for example, in system 300 the cutouts may be formed spaced away from the edges of the back and front panels, such as in a mid-region of the panels.
Ventilation means may be any other kind of opening small enough to prevent bees from passing through. For example, the ventilation means may comprise an array of slits having a width of no more than ⅛″.
Ventilation means may not be evenly distributed across the front and back panels but rather arranged in other arrangements that provide suitable ventilation for the beehive and suitable overlap of the ventilation means as between the slidable front panel and the back panel as described herein.

The components of systems 10, 100, 200 and 300 may be made of UV resistant polyvinyl chloride (PVC), or any other suitably stiff, water resistant material that can substantially withstand gnawing by bees and pests. The material may be white in colour.

This application is intended to cover any variations, uses, or adaptations of the invention using its general principles. Further, this application is intended to cover such departures from the present disclosure as come within known or customary practice in the art to which this invention pertains and which fall within the limits of the appended claims. Accordingly, the scope of the claims should not be limited by the preferred embodiments set forth in the description, but should be given the broadest interpretation consistent with the description as a whole.

1. A ventilation and entrance adjustment system for a beehive, the system comprising:
a first panel comprising a first cutout and an entrance adjustment portion flanking the first cutout; and
a second panel disposed rearward of the first panel and comprising a second cutout,
wherein the first panel is slidable relative to the second panel, wherein in a closed configuration the entrance adjustment portion blocks the second cutout to prevent bees from passing through, and in an open configuration the entrance adjustment portion either does not block, or only partially blocks, the second cutout to allow bees to pass through; and
wherein the first panel and the second panel each comprise ventilation means, wherein in the closed configuration and in the open configuration the ventilation means of the first panel are arranged to at least partially overlap with the ventilation means of the second panel to allow air to flow through the system.

2. A system according to claim 1 further comprising a guide assembly, the guide assembly comprising an upper guide and a lower guide, the upper guide configured to receive upper edges of the first panel and the second panel, and the lower guide configured to receive lower edges of the first panel and the second panel, wherein the lower guide has cutouts corresponding to the second cutouts of the second panel.

3. A system according to claim 2, wherein the upper guide and the bottom guide each comprise double U-shaped channels for receiving the upper and lower edges of the first and second panels.

4. A system according to claim 2, wherein the second panel is integral with the upper guide and the lower guide, and the upper guide and the lower guide each comprise a U-shaped channel for receiving the upper and lower edges of the first panel.

5. A system according to claim 2 wherein the lower guide comprises a cutout corresponding in location to the second cutout, and wherein a height of the first cutout and a height of the second cutout are substantially equal.

6. A system according to claim 5 wherein the heights of the first and second cutouts range from ⅜″ to ½″ and the widths of the first and second cutouts range from 1″ to 3″.

7. A system according to claim 6 wherein the first cutout is located along a lower edge of the first panel and the second cutout is located along a lower edge of the second panel.

8. A system according to claim 7 wherein side edges of the first and second cutouts angle outward in the downward direction.

9. A system according to claim 8 wherein the second panel spans an entrance width of the beehive.

10. A system according to claim 9 wherein a width of the second panel ranges from 6″ to 18″, is about 16½″, or is about 7¾″, and wherein the height of the first and second panels is about 1¾″.

11. A system according to claim 9 wherein a height of the first panel and a height of second panel are substantially the same.

12. A system according to any one of claims 11 wherein the second panel is fixed.

13. A system according to claim 12 wherein a distance between the first panel and the second panel is no greater than ⅛″.

14. A system according to claim 13 wherein the first panel and the second panel are constructed from 1/16″ thick UV resistant polyvinyl chloride (PVC).

15. A system according to claim 14 wherein the ventilation means account for at least 25% of the surface area each of the first panel and the second panel.

16. A system according to claim 15 wherein the ventilation means comprise ⅛″ diameter perforations substantially evenly distributed across the first panel and the second panel.

17. A system according to claim 15 wherein the ventilation means comprise ⅛″ wide slits substantially evenly distributed across the first panel and the second panel.

18. A beehive comprising:
a top cover;
a plurality of supers;
a bottom board defining an entrance; and
a system according to claim 1 at the entrance for ventilating the beehive and adjusting the size of the entrance.

19. A beehive according to claim 18 wherein the second cutout is centrally located along a width of the bottom board.

20. A beehive according to claim 19 wherein the beehive is a Langstroth beehive.
